(19) United States
(12) Patent Application Publication
(10) Pub. No.: US 2022/0243697 A1
(43) Pub. Date: Aug. 4, 2022

(54) Methods and Related Devices for Converting Wave Motion to Usable Energy on a Structure or a Standalone Configuration.

(71) Applicant: Narayan R. Iyer, Cedar Rapids, IA (US)

(72) Inventor: Narayan R. Iyer, Cedar Rapids, IA (US)

(21) Appl. No.: 17/305,386

(22) Filed: Jul. 6, 2021

Related U.S. Application Data
(60) Provisional application No. 63/199,936, filed on Feb. 3, 2021.
(60) Provisional application No. 63/200,016, filed on Feb. 10, 2021.

(51) Int. Cl. F03B 13/18

(52) U.S. Cl. CPC F03B 13/186; F05B 2220/707; F05B 2260/40

(57) ABSTRACT

The present disclosure provides a method and related systems for converting the alternating motion produced by an array of floats resting atop the surface of a body of water into unidirectional motion and converting that motion into usable energy on a common structure. A vessel constructed as such is also provided which experiences a reduced effect of vertical perturbations from waves. There is also provided a method for a standalone system using a float and a connected or merged hydrofoil to generate usable unidirectional motion from water waves.

### CROSS REFERENCES TO RELATED APPLICATIONS

The present application claims the benefit and priority of U.S. application no. U.S. 63/199,936, filed 3 Feb. 2021 and US application no. U.S. 63/200,016 filed 9 Feb. 2021.

### FIELD OF INVENTION

The present invention relates generally to the field of wave motion energy harvesting. More specifically, the present invention relates to use of an array of floats connected with a common vessel or structure above it by a corresponding array of alternating to direct motion converters to generate usable unidirectional motion. Alternatively a standalone configuration, without the need for a common structure, of a float and connected hydrofoil system, is disclosed to harness wave motion using a corresponding alternating to direct motion converter.

### BACKGROUND

It is widely known that wave power is an abundant clean energy resource that has thus far remained untapped due to the expense of such endeavors, since any structure built to harvest wave energy suffers extreme environmental conditions and wear.

Many attempts have been made to provide a solution to the foregoing issues, with submerged reactors for converting the wave motion to usable energy being popular due to the lower level of damage suffered beneath the surface. For example, U.S. Pat. No. 8,826,658 describes a point absorbing wave energy harvesting device which comprises a body that converts and stores wave energy obtained from a buoyant float connected with it which rests at the surface while the main body remains submerged under the water.

Some solutions have also attempted to provide energy conversion at the surface by anchoring surface-based wave motion generators to the sea bed beneath such as the device described in WO2014089983. Such solutions are naturally expensive to install as they require secure anchorage to a seabed.

Another problem relevant to the present invention is that wave motion at a water body surface, in particular the vertical aspect of the surface perturbations, affects vessels that pass through the perturbations. The vertical perturbations cause both discomfort to passengers of such vessels and hinder the progress of the vessels by providing additional water resistance and effectively increases the distance the vessel must travel over the water body surface. It is within this context that the present invention is provided on a structure.

Additionally, a novel standalone system, not necessarily as a part of a common structure, is disclosed in this invention. This system serves to increase overall usable motion harnessed and thus overall energy produced, compared to existing mechanical endeavors of similar cost. The novel standalone mechanism disclosed herein combines the advantages of a float that is partially submerged and/or floating (as opposed to a fully submerged float), and a fully submerged hydrofoil (as opposed to a partially submerged hydrofoil), to produce a combined unit that harnesses increased wave forces for the alternating to direct motion converter to convert to a usable, unidirectional form.

### SUMMARY

The present disclosure provides a method and related device for converting the alternating motion produced by an array of floats interfacing a surface of a body of water into unidirectional motion and converting that motion into usable energy. The methods and related device may be provided on a structure connected with solid earth, a free-floating structure, and/or as an interface between a vessel and the water body; the term “structure” hereon broadly refers to any of the stated applications. The methods and devices are provided as the interface between a structure and the water body surface. A vessel constructed as such is also provided which experiences a reduced effect of vertical perturbations from waves. Additionally, an alternate standalone system is also disclosed that does not necessitate a common structure.

Thus, according to one aspect of the present disclosure there is provided a method of converting wave motion to usable energy, the method comprises the steps of: providing an array of floats on a surface of a body of water, connected with a common structure above the array and being configured to move in an alternating translational pattern with respect to the common structure in response to perturbations of the water body surface; converting the alternating movement of each float in the array to a unidirectional motion using a corresponding array of Alternating to Direct Motion Converters, ADMCs, which may form part of a link between the array of floats and the common structure; and passing the converted energy to a storage apparatus and/or further conversion apparatus such as an electric generator.

In some embodiments, the array of floats comprises corresponding linear guides within the link between the float and the common structure to facilitate the translational alternating movement of the float.

In one embodiment, the array of floats comprises one or more floats connected with the common vessel or structure by a compressible element that can receive kinetic energy, store energy then release energy, to aid in creating alternating translational motion of each such float with respect to the common vessel.

In some embodiments, the compressible element comprises a spring and/or hydraulic mechanism storing potential energy created by each compression, then releasing this energy in order to recoil (extend and return) the float to an original position once the water body surface perturbation has passed. A hydraulic mechanism that transfers a significant portion of the energy stored by compression to other components via valves or conduits does not constitute a recoil compressible element. The term “compressible element” herein refers to such mechanisms that provide the stated significant recoil functionality.

An alternative mechanism to the compressible element is one that lifts a heavy weight when the float is raised by a crest, and once the crest passes, the weight falls and lowers the float forcefully toward the current position of the water level. The use of said weight mechanism and/or a compressible element is useful in ensuring the quick return of the buoy back down after a passing wave crest (opposing output loads such as generator back-torque or other frictional forces in the system), thus quickly preparing the float to encounter the next wave.

In an embodiment, one or more linear guides in an array may be oriented to maximize the translation of the float based on one or more environmental conditions such as wave speed.

In some embodiments, one or more floats in the array are rotationally connected with the structure, to be able to freely rotate laterally relative to the structure, preferably in a substantially horizontal plane and/or in a plane substantially perpendicular to the linear guide, based on the direction of the horizontal motion component of the water surface. An example of this rotational connection is at least one cylindrical joint configured between the float and compressible element, between the compressible element and the structure, and/or as a part of the compressible element itself. In some embodiments, the shape of said rotationally connected floats may allow for the induction of a torsional force based on the direction of the water body horizontal perturbation, so as to allow the float to generally point to the direction of the substantially horizontal component of the wave.

In some embodiments, the float is shaped to have a slanted angle of attack relative to the horizontal component of the wave motion, in order to harness forces of said horizontal component and convert them to forces along the direction of the linear guide, thus adding to the existing buoyancy forces faced by said float.

In some embodiments, the float that is interfacing the surface of the body of water is connected to a hydrofoil that is submerged into the body of water and configured to generate a lift force component along the linear guide. The surface float effectively captures buoyancy forces (as opposed to a submerged float), whereas the submerged hydrofoil effectively generates lift forces (as opposed to a partially submerged hydrofoil). An appropriately configured hydrofoil, to produce said component of lift, is one that has a positive angle of attack relative to the incoming wave motion component in the horizontal plane and/or has a shape with a positive coefficient of lift at an angle of attack of 0 degrees relative to the horizontal plane. This combination allows for increased forces along the linear guides facilitating greater translational motion.

In one embodiment, the float itself, or portions of the float is a hydrofoil that is either submerged or partially submerged. The hydrofoil creates lift forces, from substantially horizontal wave motion components, that serve to increase motion along the linear guide. In some embodiments said hydrofoil may be buoyant to add to the lift forces.

In some embodiments, the array of floats is fitted on a frame having connections of adjustable length between the floats for controlling the separation between the floats. In some embodiments, the method further comprises the step of determining the wavelength and amplitude of the water surface perturbations with a local sensor, calculating an optimal float separation, and adjusting the float separation to match the optimal float separation.

In some embodiments, the floats may be detachable from the frame to facilitate the adaptation of the array of floats to different weights and conditions. In some embodiments, the method further comprises providing an appendage on the underside of the vessel having a buoyant element to increase the total buoyancy of the vessel.

In some embodiments, the method further comprises utilizing the converted energy to power a generator on the common structure. The method may further comprise transmitting, using a power transmitting unit, converted energy through a flywheel element to store as usable unidirectional kinetic energy for the generator input.

In some embodiments, the method is applied on a transportation vessel with an electric or electric hybrid engine which uses the converted energy to recharge the ship battery. In some embodiments, the method is applied on a transportation vessel with a non-hybrid engine for powering the vessel's electronic systems.

In some embodiments, the array of floats is further configured to reduce vertical perturbations experienced by the vessel as a result of vertical perturbations in the surface of the water body.

According to another aspect of the present disclosure, there is provided a device comprising of a common structure connected with an array of floats by a corresponding array of Alternating to Direct Motion Converters, ADMCs; the array of floats and corresponding array of ADMCs being configured to carry out the method of any one or more of the above-described embodiments.

According to another aspect of the present disclosure, there is provided a method wherein the float and hydrofoil combination may be used outside of the scope of a common structure. In one embodiment, a float that is generally partially submerged and/or floating is connected with a hydrofoil that is generally fully submerged, to form a float and hydrofoil combination; this combination is connected with an energy accumulation and release mechanism (a recoil mechanism), such as a linear spring and/or a weight lifting mechanism, which stores kinetic energy (as potential energy) when motion occurs in a first direction, and releases kinetic energy in the opposite direction when the motion in said first direction subsides. Therefore when a wave crest arrives, the float and hydrofoil combination moves upward; then after the wave subsides, the combination is restored to an equilibrium position to prepare the combination to encounter the next wave; this alternating motion is transferred to an appropriately configured alternating to direct motion converter for conversion to unidirectional motion for further energy conversion or storage.

In one embodiment, there is provided a device comprising a float and hydrofoil combination connected with an alternating to direct motion converter, being configured to carry out the stated combination method, not necessarily being connected with a common structure.

### BRIEF DESCRIPTION OF THE DRAWINGS

Various embodiments of the invention are disclosed in the following detailed description and accompanying drawings.

FIG. 1 illustrates a flow diagram of a core set of steps of the disclosed method for converting alternating wave motion energy to usable unidirectional motion on a structure.

FIG. 2 illustrates a first example configuration of a float assembly for carrying out the disclosed method.

FIG. 3 illustrates a second example configuration of a float assembly for carrying out the disclosed method.

FIG. 4 illustrates a third example configuration of a float assembly for carrying out the disclosed method, wherein the orientation of the linear guide and compressible element are adjustable to increase the capture of horizontal force components, adding to vertical wave force components.

FIG. 5 illustrates a fourth example configuration of a float assembly for carrying out the disclosed method, wherein the float is rotationally connected with respect to the structure, to allow lateral rotation of the float.

FIG. 6 is the top view of an example float for carrying out the disclosed method, wherein the float is shaped to rotate toward the direction of the wave.

FIG. 7 is a perspective view of a second example float for carrying out the disclosed method.

FIG. 8 is a perspective view of a fifth example configuration of a float assembly for carrying out the disclosed method, wherein the float interfacing the surface of the body of water is connected to a submerged hydrofoil.

FIG. 9 is a perspective view of a sixth example configuration of a float assembly for carrying out the disclosed method, wherein the float itself is a submerged or partially submerged hydrofoil.

FIG. 10 is a perspective view of a seventh example configuration of a float assembly for carrying out the disclosed method, wherein the partially submerged float is merged with a fully submerged hydrofoil

FIG. 11 is a perspective view of an eighth example configuration of a float assembly for carrying out the disclosed method, wherein the float comprises a merged hydrofoil portion.

FIG. 12 illustrates an example arrangement of a vessel equipped with an array of floats for carrying out the disclosed method and various other modifications.

FIG. 13 illustrates an example configuration of an array of floats connected with a common structure by an adjustable frame.

FIG. 14 illustrates an example standalone (without necessity of common structure) configuration of a float and hydrofoil combination connected with a spring.

FIG. 15 illustrates an example standalone configuration of a float and hydrofoil combination connected with a heavy weight.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any one or any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “component”, in the context of a force and/or motion, specifies the influence of said force and/or motion in a given direction. The phrase “connected with”, in the context of a float and hydrofoil, herein refers to any one or any combination of the following: a connection between the hydrofoil and the float by a connection member, a direct connection between the hydrofoil and the float, and/or a merging of said two entities to form one body. As used herein, a lateral rotation of a physical item/items is a movement that is noticeable if the associated item/items is visually projected onto a horizontal plane; a lateral rotational moment is a torsional force that causes said movement.

The present disclosure provides a method of operating an array of floats (defined herein as any body capable of physically interfacing with a body of water with the purpose of inducing and transferring upward forces) which are connected by a corresponding array of Alternating to Direct Motion Converters (ADMCs) with a common structure.

If the method of the present disclosure is applied on a vessel, in particular a maritime vessel likely to be traversing waves on a regular basis, with the floats interfacing with the water surface and supporting its weight instead of the hull of the vessel, energy can be harvested from the vertical perturbations experienced by the floats while at the same time reducing water resistance and effective distance traveled by the vessel, and simultaneously reducing the vertical perturbations experienced by occupants of the vessel.

Alternatively, the array can act as a simple energy harvesting facility which can be mounted to any structure connected with the earth, such as for example the underside of any above-water structure anchored to the shore such as a pier.

Alternatively, standalone systems may occur without the need for a common structure, to generate usable unidirectional motion from water body perturbations.

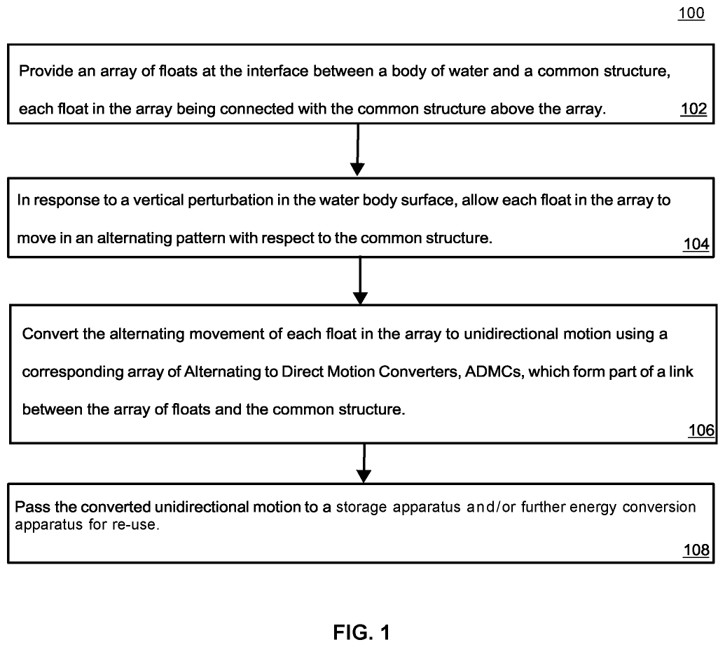

Referring to FIG. 1, a flow diagram of a core set of steps of the disclosed method 100 for converting alternating wave motion energy to usable unidirectional motion is shown.

In a first step 102, the method involves providing an array of floats interfacing a body of water, each float in the array being connected with a common structure.

As the array of floats are in contact with the water surface they will rise and fall in line with perturbations of that surface, i.e. the perturbations caused by the motion of waves passing by the array underneath the common structure.

All vessels encounter waves on a frequent basis, meaning that placement of the array of floats at the interface between a common vessel and a body of water will ensure the floats are regularly moved up and down with respect to the vessel, causing alternating motion. If the common structure is a vessel, generally the floats will span the full interface between the common vessel body and the water surface, however there may be some examples where it is advantageous for a portion of the common vessel body to also interface with the water or even to be submerged. This may assist with load-bearing issues for example.

In a second step 104, the method involves, in response to a vertical perturbation, i.e. a wave, in the water body surface, allowing each float of the array to move in an alternating pattern with respect to the common structure.

This step requires that each float is connected with the body of the common structure above by a mechanism that has at least one degree of free translational movement. Structures suitable for achieving this are described in detail in the following sections.

In a third step 106, the method involves converting the alternating movement of each float in the array to a unidirectional motion using a corresponding array of Alternating to Direct Motion Converters, ADMCs, which link the array of floats to the common structure. There may be one ADMC per float, multiple ADMCs per float and/or one ADMC may link a plurality of floats to the body above.

At a granular level, when a wave crest hits a given float, the float will be raised vertically, conveying an upward movement to an associated ADMC, then once the wave crest has passed, the float will be forcefully caused to lower due to the potential energy accumulated in the connection to the common structure (the connection may comprise some spring, hydraulic, fluid/gas compression and/or other elastic or gravitational mechanism with the ability to recoil to an original position) (specific configurations described below). The lowering of the float to its original position will also convey kinetic energy to the ADMC but in the opposing direction, and the ADMC is configured to use both directions from the movement to propel a connected component in a unidirectional manner.

Various different types of ADMC are known in the art and suitable for fulfilling this functionality of converting the alternating wave motion from the floats at the interface between the floats and the common structure. The specific details of ADMCs will not be explored in the present application, as while they fulfill a function of the invention they are not the focus, however suitable ADMCs are disclosed in the applicant's co-pending applications 63/200,015 (part 2 unit) and U.S. 63/202,180, the contents of which are incorporated herein by reference in their entirety.

Suffice to say that for the purposes of this application, an ADMC is a mechanical and/or hydraulic arrangement that extracts energy from both directions of a bidirectional movement, either translational or rotational, and uses the extracted energy to produce unidirectional motion of either a mechanical component and/or fluid (fluid corresponds to the hydraulic arrangement).

In a fourth step 108, the method involves using the unidirectional motion to generate kinetic energy and passing the converted energy, through a power transmission unit, to a storage apparatus or further conversion apparatus, for example a generator for converting the unidirectional motion to electricity, on the common structure. Any number of mechanisms are known for storing or using unidirectional motion.

One suitable example would be that the unidirectional motion obtained is used to power a flywheel, power a generator, and/or to charge a battery. This could be particularly beneficial for vessels that utilize hybrid or electric propulsion systems.

The cycle then repeats as the next vertical perturbation, i.e. the next wave, is encountered.

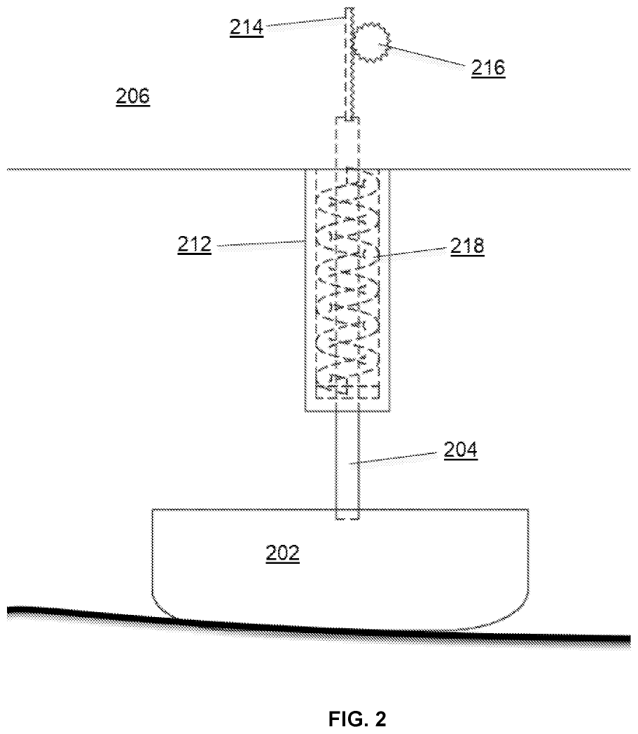

Referring to FIG. 2, a first example configuration of a float assembly attached to the underside of a structure body 206 for carrying out the disclosed method is shown.

Each float 202 is independently connected with the underside of a common structure 206 by a linear guide 212 and a compression element 218 such that vertical perturbations of the water surface cause direct translational motion of the float and compression of the element 218. A drive member 204 may be defined that can transfer translational motion to and from the float to appropriate components, such as the compressible element 218, along the linear guide 212.

The drive member 204 further comprises a toothed section 214 that interlocks with a gear 216 in such a way that motion of the float 202 causes motion of the toothed section 214 and rotates the gear. Thus, the alternating translational motion of the float can be converted to bidirectional rotational motion of the gear which can then be converted to unidirectional motion on the vessel 206 by an appropriately configured ADMC (not pictured) connected with the gear 216 or connected with the interface between the vessel body 206 and the compressible element 218.

In the present example, the compressible element is also provided with a spring-like component 218 which becomes energized when translational movement toward the structure occurs along the linear guide 212, building up potential energy which, when the vertical perturbation in the water surface has passed, causes the compressible element 218 to expand once more, causing an opposing motion in the toothed section 214 which is also transferred to the gear 216 and ADMC, and returns the float to its original position ready for the next wave.

A spring is merely an example of an appropriate mechanism. Anything capable of storing potential energy from the wave, and recoiling said energy as kinetic energy could also be used as the compressible element 218.

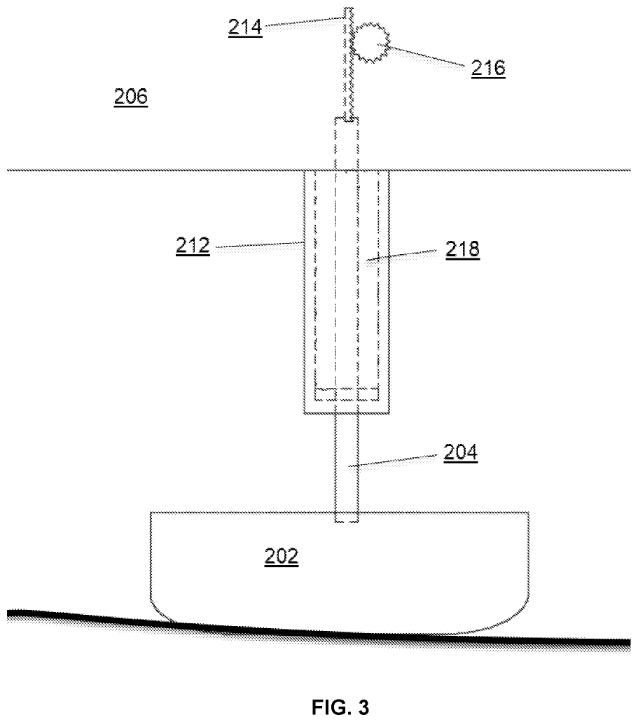

Thus, referring to FIG. 3, a second configuration of a float assembly attached to the underside of a common structure body 206 for carrying out the disclosed method is shown with a hydraulic piston 218 containing a compressible fluid which fulfills the same function as the spring-like element of FIG. 2, with an appropriately configured ADMC (not pictured) coupled with the gear 216.

Additional modifications can be made to the disclosed configuration to account for environmental factors. For example, the linear guide and/or compressible element could be angularly oriented for alternating translational motion along an axis angled away from the vertical.

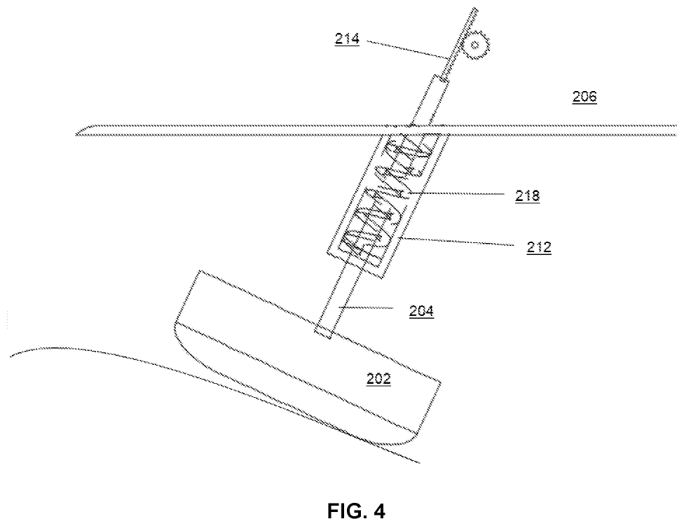

Thus referring to FIG. 4, a third example configuration of a float assembly attached to the underside of a structure body 206 for carrying out the disclosed method is shown, wherein the orientation of the linear guide and/or compressible element can be altered based on the waves in the region and/or waves at a certain time, for example, a steeper angle away from the vertical is better suited for faster traveling waves (faster horizontal component of wave motion). Mechanisms to allow adjustability of said angle can include a ball joint (not pictured) and appropriately placed actuators (not pictured).

Additional environment-based adjustments can also be incorporated to the disclosed configuration, such as allowing lateral rotation of the float with respect to the structure.

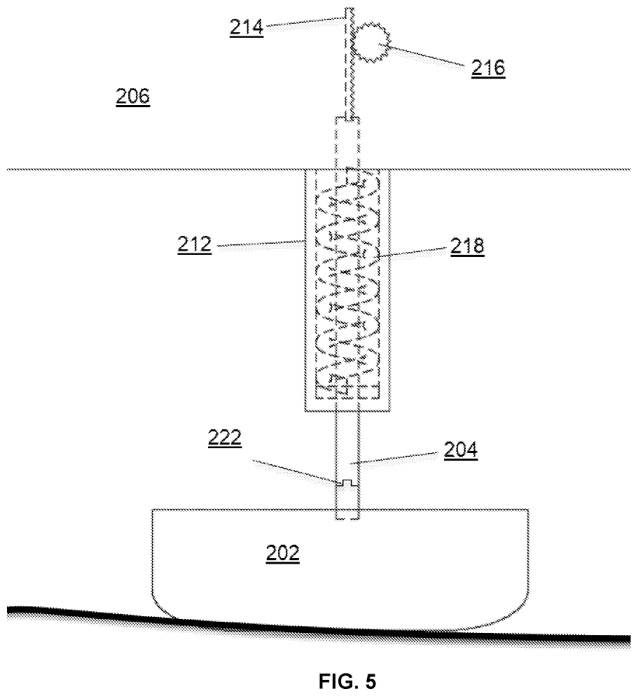

Referring to FIG. 5, a fourth example configuration of a float assembly attached to the underside of a structure body 206 for carrying out the disclosed method is shown with a float 202 that is free to rotate in a substantially horizontal plane and/or a plane that is perpendicular to the linear guide 212, facilitated by a cylindrical joint 222 that forms a link between the float 202 and the structure body 206. In some embodiments, the rotational connection 222 is a ball joint, which can allow the float to rotate in a substantially horizontal plane, toward the substantially horizontal direction of the water wave, even when the linear guide is oriented away from the vertical.

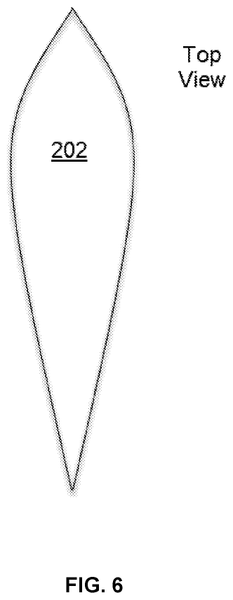

Referring to FIG. 6, an example float 202 is shown from a top view that is shaped to induce lateral rotational moments about its center of gravity, according to the horizontal component direction of the encountered wave motion, when said wave component direction differs from the current pointing direction of the float. This moment allows float 202 to turn toward the direction of the oncoming waves, in order to remain streamlined toward said direction, thus minimizing unwanted lateral forces that would cause stress to the structure.

Additional shape modifications can be made to enhance the capture of other desirable forces such as lift.

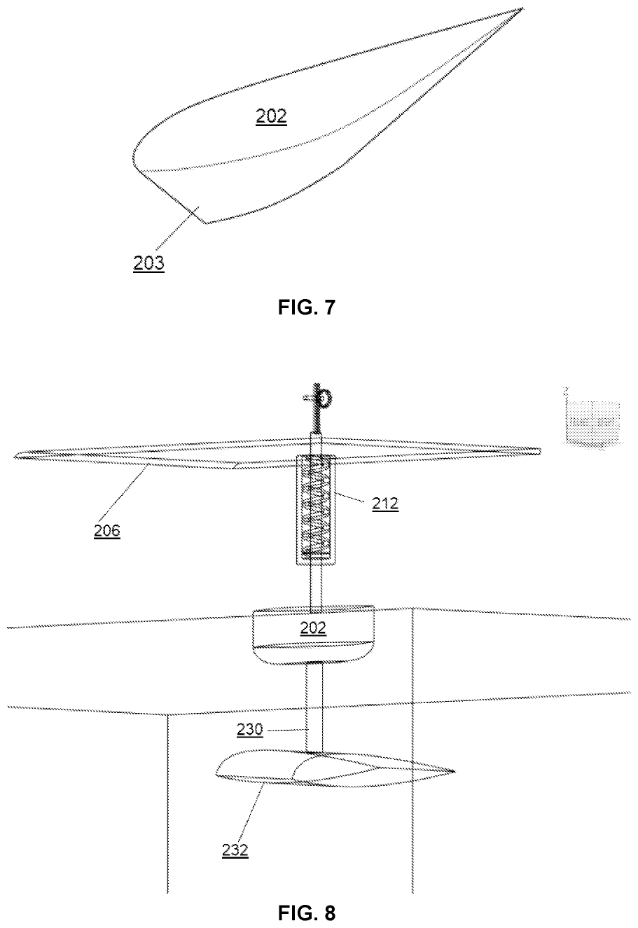

Thus referring to FIG. 7, a perspective view of an example float 202 is shown that is shaped to possess an angle of attack 203 that captures wave forces from wave motion components that are perpendicular to the linear guide 212, and produce resulting lift force components in the direction of the linear guide 212 (shown in previous figures).

An addition of an appropriately configured hydrofoil increases lift forces transferred to the ADMC.

Thus referring to FIG .8, a fifth example configuration of a float assembly attached to the underside of a structure body 206 for carrying out the disclosed method is shown with a float 202 interfacing with the surface of the water body, connected, by a connecting member 230, with a submerged hydrofoil 232 that is configured to produce lift force components along the linear guide 212, due to the hydrofoil's positive angle of attack relative to the wave motion component perpendicular to the linear guide and/or due to the shape of the hydrofoil allowing it to have a positive coefficient of lift at a zero angle of attack relative to said wave motion component. The surface level float 202, that is generally partially submerged and/or floating, effectively harnesses buoyancy forces (compared to a fully submerged float), while the generally fully submerged hydrofoil 232 effectively generates lift (compared to a partially submerged or floating hydrofoil); therefore a combination of the two elements will effectively produce increased translational forces along the linear guide 212, thus increasing the motion converted by the ADMC.

Possible hydrofoils that are suitable for producing said lift force components may also include planar-directionally agnostic hydrofoils, such as one shaped similar to a frisbee and/or saucer; such hydrofoils generate lift when a component of fluid motion occurs in the plane of the hydrofoil presence, regardless of the direction of said component.

In some embodiments, the float itself may be a hydrofoil configured to produce a lift force component along the direction of the linear guide.

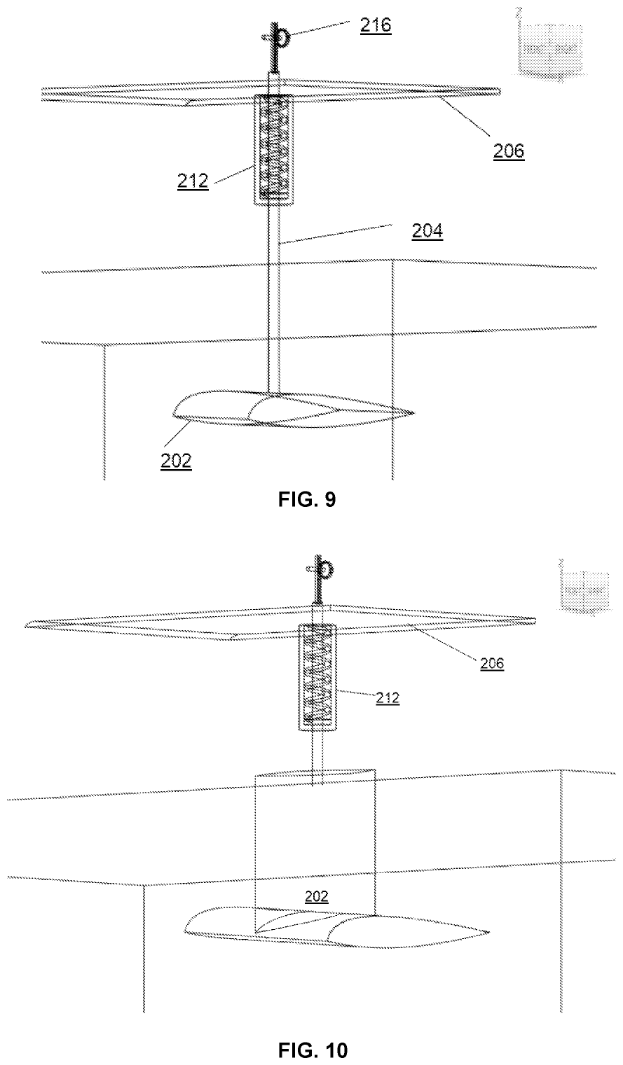

Thus referring to FIG. 9, a sixth example configuration of a float assembly attached to the underside of a structure body 206 for carrying out the disclosed method is shown with a float 202 that itself is a hydrofoil configured to generate lift force vector components along the direction of the linear guide 212; such hydrofoil may be buoyant or not buoyant.

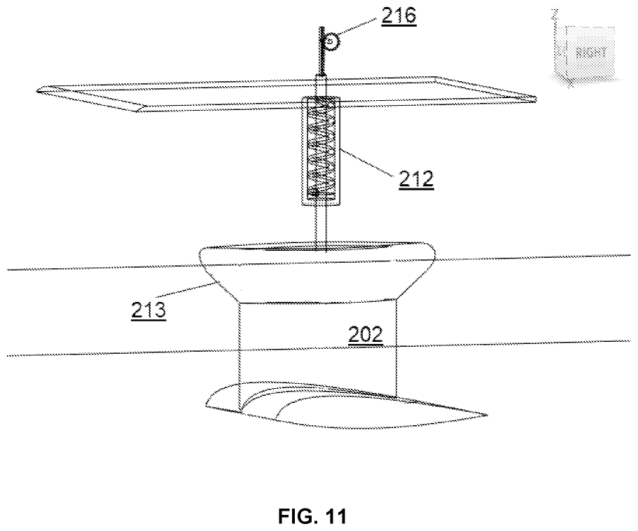

Extending the designs from FIG. 8 and FIG. 9, it may be beneficial to have a float 202 that comprises a buoyant portion that is partially submerged merged with a hydrofoil that is generally fully submerged. Thus referring to FIG. 10, such a float 202 is shown in a seventh example configuration of a float assembly attached to the underside of a structure body 206 for carrying out the disclosed method. FIG. 11 shows an example of a similar arrangement to FIG. 10, but with the float 202 having a slanted angle of attack 213 where it is expected to generally interface with the water body surface. This may serve to increase lift as well as allow for significant increases in buoyancy with each unit rise in the water surface (not a linear increase).

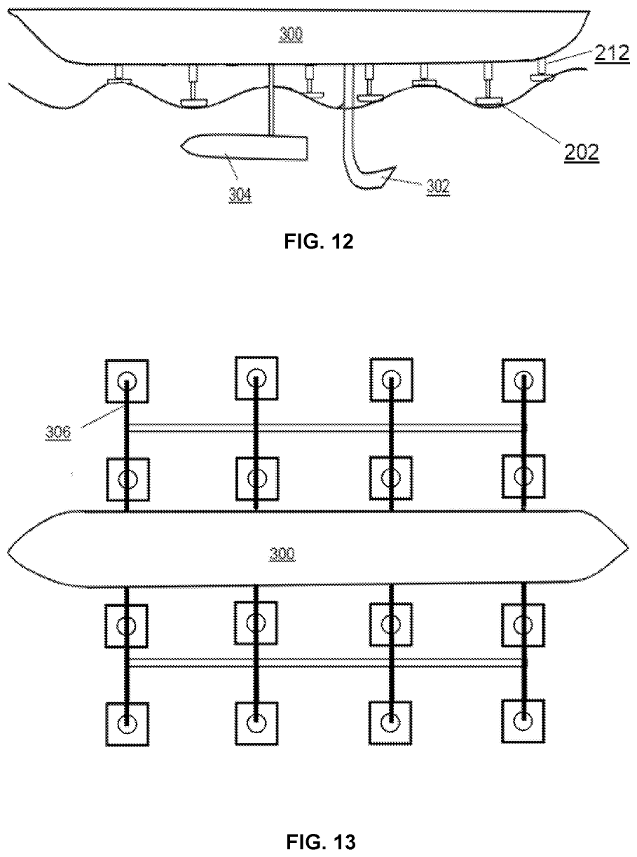

FIGS. 12 and 13 show actual arrays of the above-described float configurations mounted on a vessel.

In particular, referring to FIG. 12, a vessel 300 is shown from the side traversing various perturbations on the surface of a body of water. The vessel 300 comprises an array of floats having corresponding compressible elements connecting them to the underside of the vessel and which completely span the interface between the vessel body 206 and the body of water.

As such, the vessel is further provided with an extendible propulsion system 302 that reaches down into the water in order to control the vessel navigation. The system 302 may for example be a set of propellers.

Also shown is a submerged buoyant element 304 rigidly connected with the underside of the vessel 300 and which rests under the surface of the water to help support the weight of the vessel. Element 304 is an optional feature but potentially helpful in constructions such as that illustrated where the entire weight of the vessel 300 would otherwise be resting on the array of floats.

If the overall system is too heavy (the floats sink), additional float systems can be added. Especially if a frame is used below the vessel body to connect the float systems to the vessel.

Referring to FIG. 13, the same vessel 300 and array of floats is seen from a top-down view. As can be seen, the floats are mounted on a frame 306 that extends outwards from either side of the vessel body for balance.

The support frame 306 itself can be structured to allow attachment or detachment of additional floats. For example, if the vessel weight increases, it may be beneficial to attach additional floats to the frame 306.

Furthermore, the frame 306 may be adjustable to allow control over the separation between floats and/or float pairs. Indeed, the float spacing can be adjusted to account for hydrodynamic drag, wake interference, or optimize wave energy extraction based on the ship's current parameters (such as speed, weight etc) or the regional oceanic conditions.

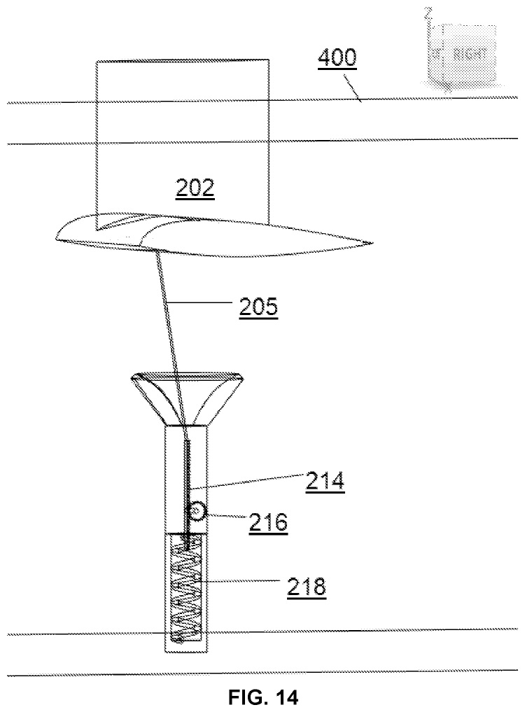

In another embodiment, the float and connected hydrofoil combination can be implemented to produce useful energy outside of the scope of a common structure possibly carrying an array of such floats. A system without the necessity of a common structure between a possible plurality of said floats is referred to as “standalone” herein. Thus referring to FIG. 14, an example standalone configuration for harnessing usable energy is shown, comprising a float and merged hydrofoil combination 202, connected by a tensile member 205, with an energy accumulation and release mechanism (recoil mechanism: linear spring) 218. The interface between the tensile member 205 and the linear spring 218 is a rigid toothed section 214 that is coupled to a gear 216, which in turn transfers motion to an appropriately configured ADMC to generate unidirectional motion.

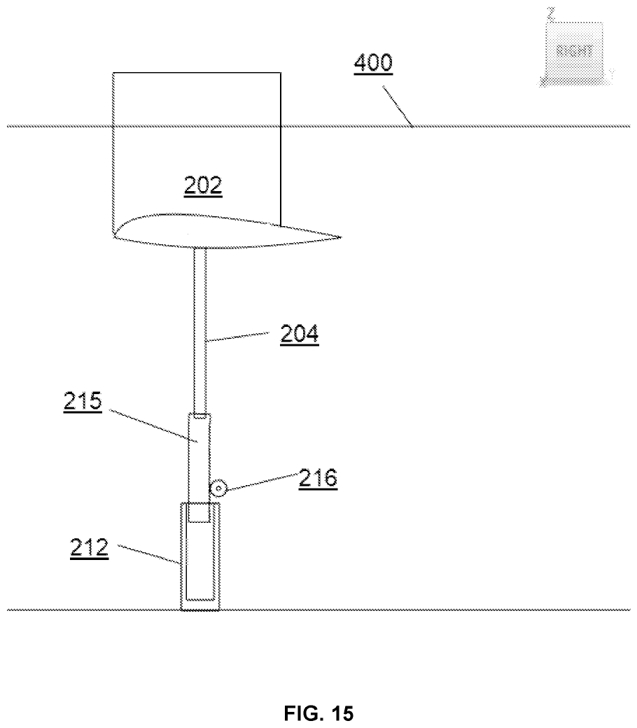

In another embodiment, a weight lifting mechanism can be used instead of a spring to achieve energy accumulation and release (recoil mechanism). Thus, referring to FIG. 15, an example standalone configuration for harnessing usable energy is shown, comprising the float 202 of FIG. 14, but connected to a heavy weight 215, instead of a linear spring, by a connection member 204. When a wave crest hits the float, the float and hydrofoil combination 202 raises the heavy weight 215, then when the wave passes the float, and the trough region is faced, the heavy weight 215 drops the float, returning it to an original position at which it is ready to encounter the next wave. The alternating motion faced by gear 216 is converted to unidirectional motion by an appropriately coupled ADMC.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and related devices for converting wave motion to usable energy on a vessel or structure have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of converting wave motion to usable energy on a structure, the method comprising the steps of:
providing an array of floats to interface with a body of water, each float in the array being connected with a common structure which is above the array of floats and being configured to move translationally in an alternating pattern along corresponding linear guides, with respect to the common structure, in response to perturbations of the water body;
converting the alternating translational movement of each float in the array to a unidirectional motion using a corresponding array of Alternating to Direct Motion Converters, ADMCs.

2. The method according to claim 1, further comprising a step of: transmitting the converted unidirectional motion to any of a storage apparatus and an energy conversion apparatus (such as an electric generator).

3. The method according to claim 1, wherein the array of floats comprises one or more floats connected with the structure by any of a compressible element and another mechanism to accumulate and release energy (such as weight lifting), to store energy from each wave-forced movement of the float in order to return the float to an original position once said wave-forced movement subsides, to create alternating translational motion of each such float with respect to the structure.

4. The method according to claim 1, wherein at least one of the linear guides is oriented to increase the translational alternating movements of the float to facilitate the capture of horizontal motion components of water body perturbations in addition to vertical perturbation motion components.

5. The method according to claim 1, wherein at least one float in the array is rotationally connected with the structure to facilitate lateral rotation of the float with respect to the common structure.

6. The method according to claim 5, wherein said floats comprise one or more floats that have a shape that causes it to rotate according to the direction of the encountered wave motion component on the horizontal plane.

7. The method according to claim 1, wherein at least one float in the array comprises an oblique surface with an angle of attack that converts horizontal force components of the encountered wave into force components along the direction of the linear guide.

8. The method according to claim 1, wherein at least one float in the array is connected with a hydrofoil that is appropriately configured to generate lift force components along the linear guide when encountering water motion.

9. The method according to claim 1, wherein at least one float in the array comprises at least a portion of itself that is a hydrofoil configured to generate lift force components along the linear guide.

10. The method according to claim 1, wherein a subset of the array of floats is fitted on a frame having connections of adjustable length between the floats for controlling the separation between the floats when encountering water motion.

11. A device for converting wave motion to usable energy on a structure, the device comprising:
an array of floats, with each float in the array being connected with a common structure which is above the array of floats and being configured to move translationally in an alternating pattern along corresponding linear guides with respect to the common structure, in response to perturbations of the water body;
a corresponding array of Alternating to Direct Motion Converters, ADMCs, configured to receive the alternating motion from corresponding floats, to convert the alternating translational movement of each float in the array to a unidirectional motion.

12. The device according to claim 11, further comprising any of a storage apparatus and an energy conversion apparatus (such as an electric generator), to receive unidirectional motion from the ADMC.

13. The device according to claim 11, wherein the array of floats comprises one or more floats connected with the structure by any of a compressible element and another mechanism to accumulate and release energy (such as weight lifting), to store energy from each wave-forced movement of the float in order to return the float to an original position once said wave-forced movement subsides, to create alternating translational motion of each such float with respect to the structure.

14. The device according to claim 11, wherein at least one of the linear guides is oriented to increase the translational alternating movements of the float to facilitate the capture of horizontal motion components of water body perturbations in addition to vertical perturbation motion components.

15. The device according to claim 11, wherein at least one float in the array is rotationally connected with the structure to facilitate lateral rotation of the float with respect to the common structure.

16. The device according to claim 15, wherein said floats comprise one or more floats that have a shape that causes it to rotate according to the oncoming direction of the encountered wave motion component on the horizontal plane.

17. The device according to claim 11, wherein at least one float in the array comprises an oblique surface with an angle of attack that converts horizontal force components of the encountered wave into force components along the direction of the linear guide.

18. The device according to claim 11, wherein at least one float in the array is connected with a hydrofoil that is appropriately configured to generate lift force components along the linear guide when encountering water motion.

19. The device according to claim 11, wherein at least one float in the array comprises at least a portion of itself that is a hydrofoil configured to generate lift force components along the linear guide when encountering water motion.

20. A method for converting wave motion to usable energy, the method comprising:
providing a float to interface with a body of water;
providing a hydrofoil connected with said float, with said hydrofoil configured to generate vertical lift force components; and,
transferring an alternating motion to an alternating to direct motion converter, ADMC, for conversion of the alternating motion into unidirectional motion.

21. The method according to claim 20, further comprising a mechanism to return the float and hydrofoil combination back to an equilibrium state, after a wave passes the combined system and a wave charge force subsides; such a mechanism can be any of a spring and a weight-based energy accumulation and release mechanism.
